(19) United States
(12) Patent Application Publication
(10) Pub. No.: US 2026/0081998 A1
(43) Pub. Date: Mar. 19, 2026

(54) UTILIZING DEVICE INFORMATION TO DYNAMICALLY DETERMINE WHETHER TO PROVISION VISUAL VOICEMAIL

(71) Applicant: T-MOBILE INNOVATIONS LLC, Overland Park, KS (US)

(72) Inventor: Ariful Islam KAZI, Renton, WA (US)

(21) Appl. No.: 18/887,315

(22) Filed: Sep. 17, 2024

(51) Int. Cl. H04M 3/533

(52) U.S. Cl. CPC H04M 3/53333

(57) ABSTRACT

Systems and methods are contemplated herein for determining whether a UE is excluded from visual voicemail (VVM) provisioning, is eligible for VVM provisioning, or is ineligible for VVM provisioning. The method may include receiving, at VVM module, an indication to initiate a logic flow. The method may include retrieving, by the VVM module during the logic flow, device information associated with the UE. The method may include determining, based on the device information associated with the UE, whether to the UE is excluded from VVM provisioning, is eligible for VVM provisioning, or is ineligible for VVM provisioning.

### SUMMARY

The present disclosure is directed, in part to determining whether a user equipment (UE) (e.g., a smartphone) is excluded from visual voicemail (VVM) provisioning, is eligible for VVM provisioning, or is ineligible for VVM provisioning, substantially as shown and/or described in connection with at least one of the figures, and as set forth more completely in the claims.

According to various aspects of the technology, systems and methods enabling a flexible approach to managing VVM provisioning are provided. Mobile network subscribers often receive voicemails, and some UEs may be eligible for improved voicemail services, such as the use of VVM. VVM may be provisioned for a particular UE when the UE initially registers with a network. However, the UE may initially be considered ineligible for VVM and later become eligible, such as through a software update of the UE. Present systems and methods lack flexibility and are insufficient to manage VVM provisioning. A network may incorporate a VVM module to determine whether a UE is entitled to VVM provisioning. The VVM module may retrieve device information. The VVM module may perform a logic flow using at least some of the device information. The VVM module may determine, after considering at least some of the device information, that the UE is excluded from VVM provisioning, the UE is eligible for VVM provisioning, or the UE is ineligible for VVM provisioning. The VVM module may effectuate the determination of the UE's eligibility to use VVM by modifying (e.g., creating, removing, modifying the value of, a combination of these) a provisioning indicator associated with the UE to indicate the UE either is or is not entitled to VVM. This solution provides a more robust and flexible approach to determining whether a UE is eligible or is ineligible for VVM provisioning.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary logic flow for determining whether a UE is excluded from visual voicemail (VVM) provisioning, is eligible for VVM provisioning, or is ineligible for VVM provisioning in which implementations of the present disclosure may be employed; and

FIG. 4 illustrates a flow diagram of an exemplary method for determining whether a UE is excluded from VVM provisioning, is eligible for VVM provisioning, or is ineligible for VVM provisioning in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, mobile network subscribers often receive, leave, and listen to voicemails. Some particular UEs (i.e., particular manufacturer, particular software versions) may be eligible for improved voicemail services, such as the use of visual voicemail (VVM). VVM is a feature or collection of features that allows subscribers to view, manage, and listen to their voicemail messages through a visual interface without needing to dial into a voicemail service. VVM may include a message list, transcription, integration with messaging platforms, and the like.

Conventionally, VVM may be provisioned for a particular UE when the UE initially registers with a network. For example, a mobile network operator (MNO) that supports VVM may activate and provision VVM upon a UE's initial registration with the network. However, the UE may initially be ineligible for VVM and later become eligible, such as through a software update of the UE. In this example, the UE may already be considered as ineligible for VVM provisioning, and the software update will not change this prior determination. Thus, the UE may not have access to or be able to use the improved VVM services despite this software update. Present systems and methods lack flexibility and are insufficient to manage VVM provisioning.

In contrast to conventional solutions and to provide a flexible approach to VVM provisioning for UEs, the present disclosure is directed to systems and methods for determining whether a UE is or is not eligible for VVM provisioning. A network may incorporate a VVM module to determine whether a UE is eligible for VVM provisioning. The VVM module may retrieve device information, such as device identifier information (e.g., an international mobile equipment identity (IMEI)), voicemail routing (VMR) information (e.g., whether a VMR profile associated with the UE is available), mobile network operator (MNO) information (e.g., which MNO the UE is associated with and whether the MNO is eligible for VVM provisioning) and/or device software information (e.g., a UE conventionally considered incompatible with VVM has a software version that makes the UE compatible with VVM). The VVM module may perform a logic flow using at least some of the device information. The VVM module may determine, after considering at least some of the device information, that the UE is excluded from VVM provisioning, the UE is eligible for VVM provisioning, or the UE is ineligible for VVM provisioning. The VVM module may effectuate UE's eligibility for VVM provisioning by modifying (e.g., creating, removing, modifying the value of, a combination of these) a provisioning indicator associated with the UE to indicate the UE either is or is not entitled for VVM. This solution provides a more robust and flexible approach to determining whether a UE is or is not eligible for VVM provisioning.

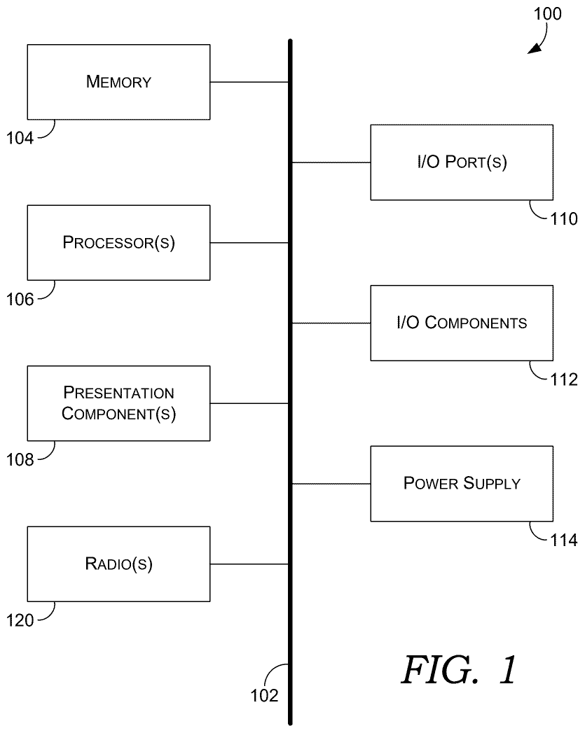

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

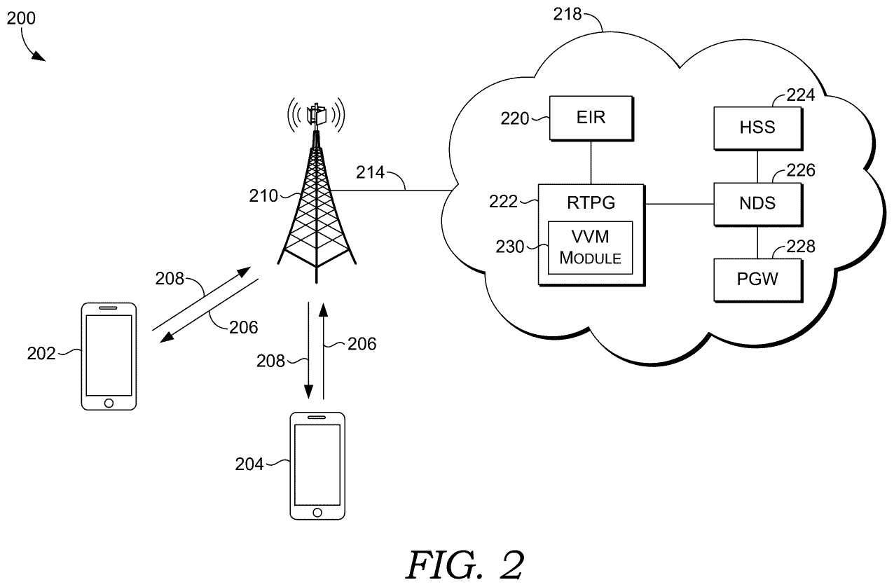

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the present disclosure. Neither should the network environment 200 be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise one or more UEs, such as a first UE 202 and/or a second UE 204, one or more base stations, such as a base station 210, and a core network 218, though in some implementations, it may not be necessary for certain features to be present. Similarly, while each component is shown in the singular, it is expressly contemplated that there may be more than one of the components described. The network environment may include a number of routers, switches, and the like. The network environment 200 is generally configured for wirelessly connecting the first UE 202 and/or the second UE 204 to information and/or services that may be accessible on one or more application servers or other functions, nodes, or servers not pictured in FIG. 2 so as to not obscure the focus on the present disclosure.

The network environment 200 comprises the first UE 202 and/or the second UE 204. While illustrated as smartphones, the first UE 202 and/or the second UE 204 and may take any number of forms (e.g., tablet, wearable device), including any device discussed with respect to FIG. 1 and may have any one or more components or features of the computing device 100 of FIG. 1. The first UE 202 and/or the second UE 204 may communicate with one or more networks to request and/or receive information and/or services.

The network environment 200 comprises one or more base stations, such as the base station 210, to which the first UE 202 and/or the second UE 204 may potentially connect to (also referred to as ‘camping on,’ ‘attaching,’ in the industry). Though network environment 200 is illustrated with one base station 210, one skilled in the art will appreciate that more base stations may be present in any particular network environment. The base station 210 of the network environment 200 is configured to wirelessly communicate with various UEs, such as the first UE 202 and/or the second UE 204. In aspects, the base station 210 may communicate with the first UE 202 and/or the second UE 204 using any wireless telecommunication protocol desired by a network operator, including but not limited to 2G, 3G, 4G, 5G, 6G, 802.11x, and the like. The base station 210 may communicate signals to one or more UEs (e.g., the first UE 202 and/or the second UE 204) via a downlink 206 and receive signals from one or more UEs via uplink 208. In response to receiving certain requests from the first UE 202 and/or the second UE 204, for example, the base station 210 may communicate with the core network 218 via a backhaul 214. For example, in order for the first UE 202 and/or the second UE 204 to connect to a desired application server, the first UE 202 and/or the second UE 204 may communicate an attach request to the base station 210, which may, in response, communicate a registration request to the core network 218 via the backhaul 214.

The core network 218 may comprise one or more network functions (NFs). As used herein, the term “network function” is used to describe a computer processing module and/or one or more computer executable services being executed on one or more computing processing modules. NFs within the core network 218 are defined by their function, as the core network 218 is a service-based architecture. The core network 218 may comprise NFs that include any one or more of an equipment identity register (EIR) 220, a real-time provisioning gateway (RTPG) 222, a home subscriber server (HSS) 224, a network directory server (NDS) 226, and a provisioning gateway (PGW) 228. Each of these NFs may communicate with each other, directly or indirectly, via interfaces existing between them. Each of the preceding NFs may take different forms, including consolidated or distributed forms that perform the same general operations. In other architectures or protocols, the NFs may be given other names, however, the NFs herein refer to functions, not specifically identified components. For example, the EIR 220 may instead be a different device management platform. In another example, the HSS 224 may instead be a unified data management (UDM) function.

Though the EIR 220, the RTPG 222, the HSS 224, the NDS 226, and the PGW 228 are illustrated in the core network 218, the core network 218 may have more or fewer NFs than shown. For example, the core network 218 may include a serving gateway (SGW), a mobility management entity (MME), and/or other NFs. Further, though the EIR 220, the RTPG 222, the HSS 224, the NDS 226, and the PGW 228 are illustrated as disposed within the core network 218, it is expressly contemplated that the location in the network environment 200 is non-limiting. For example, the NFs described above may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above.

The EIR 220, for example, is generally responsible for managing UE information (e.g., international mobile equipment identities (IMEIs)) which allows the network to allow, monitor, and/or block UEs attempting to access the network. In aspects, the EIR 220 may communicate with the NDS 226, such as to update user and/or UE information stored at the NDS 226.

The RTPG 222, for example, is generally responsible for facilitating the provisioning, activation, deactivation, and management of services for users of the network, ensuring that service and/or provisioning changes are processed and applied in real-time. The RTPG 222 may comprise a VVM module 230. The VVM module 230 is generally responsible for determining whether one or more UEs (e.g., the first UE 202 and/or the second UE 204) are eligible for VVM provisioning. In some aspects, the VVM module 230 may be configured to execute a logic flow to determine whether a UE is to be excluded from VVM provisioning (e.g., the UE is excluded from further analysis in the logic flow based on one or more determinations made during the logic flow prior to determining the UE is eligible or ineligible for VVM provisioning), the UE is included in VVM provisioning but is ineligible for VVM, or the UE is included in VVM provisioning and is eligible for VVM.

The HSS 224, for example, is generally responsible for managing user data, such as user, subscriber, and/or UE profiles, authentication credentials, and subscription details. The HSS 224 also functions in roaming contexts. For example, the HSS 224 may communicate with a visiting network to manage and update data within one or more profiles as a UE (e.g., the first UE and/or the second UE) moves between different networks. In one example, the first UE 202 may move between the first UE's 202 home network (e.g., the network the first UE 202 uses when not roaming) and a visiting network (e.g., the first UE 202 travels to a different country). The visiting network may communicate with the HSS 224 to provide updated information, such as device location information. The HSS 224 may communicate information (e.g., device location information) to the NDS 226 for storage in one or more profiles of the NDS 226.

The NDS 226, for example, is generally responsible for hosting and storing UE, user, subscription, and/or network data, and may be configured to provide various information to NFs. The NDS 226 may store various profiles, such as one or more profiles associated with the first UE 202 and/or the second UE 204 (e.g., user, subscriber, and/or UE profiles), which may include at least a portion of the device information. The NDS 226 may store device information such as device identifier information, voicemail routing (VMR) information, MNO information, device software information, and/or a combination of these. In aspects, the NDS 226 includes one or more subscription databases (e.g., a user subscription database (USD)) and/or the NDS 226 communicates with one or more subscription databases.

The PGW 228, for example, is generally responsible for managing provisioning (e.g., the configuration and activation of network services for users and UEs). The PGW 228 may act as an intermediary between service providers and the network, ensuring resources are allocated, services are activated, and settings are applied. In aspects, the PGW 228 may be configured to identify and communicate designated provisioning changes associated with one or more UEs, such as the first UE 202 and/or the second UE 204, to the NDS 226.

Relevant to the present disclosure, the VVM module 230 may be configured to perform a logic flow. During the logic flow, the VVM module 230 may retrieve device information from one or more NFs (e.g., the RTPG 222, the VVM module 230, the EIR 220, and/or the NDS 226). Based on at least some of the device information, the VVM module 230 determines whether a particular UE (e.g., the first UE 202 and/or the second UE 204) is excluded from VVM provisioning, is ineligible for VVM provisioning, or is eligible for VVM. If the VVM module 230 determines the UE is or is not eligible for VVM, the VVM module 230 may modify (e.g., create, remove, and/or modify the value of) a provisioning indicator associated with the UE to effectuate the determination and prevent or enable the UE from using VVM.

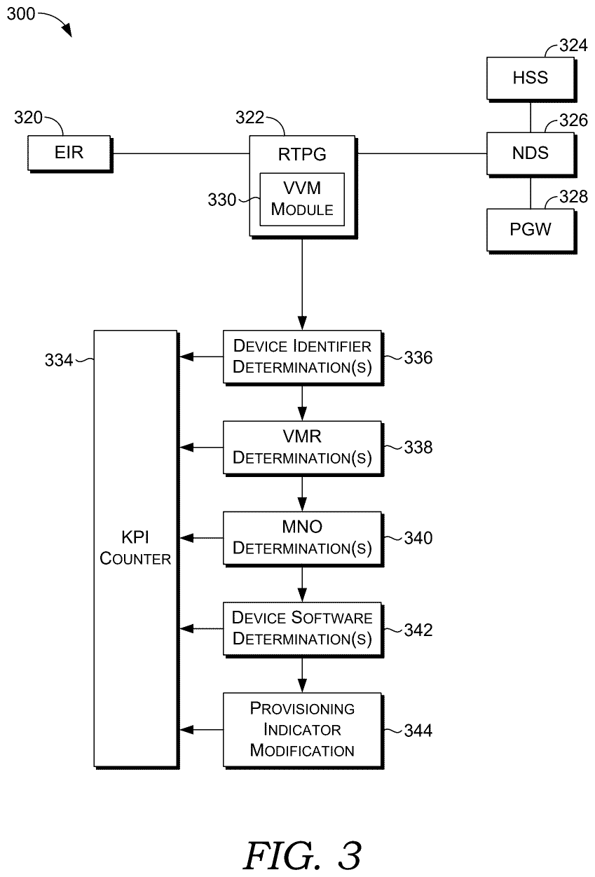

Turning now to FIG. 3, a logic flow diagram is illustrated in accordance with one or more aspects of the present disclosure. A logic flow 300 may be performed by and/or facilitated by one or more NFs discussed in greater detail herein and is not meant to exhaustively show every interaction that would be necessary to practice the invention, so as not to obscure the present disclosure. The logic flow 300 may generally involve an EIR 320 (e.g., the EIR 220 of FIG. 2), an RTPG 322 (e.g., the RTPG 222 of FIG. 2), an HSS 324 (e.g., the HSS 224 of FIG. 2), an NDS 326 (e.g., the NDS 226 of FIG. 2), a PGW 328 (e.g., the PGW 228 of FIG. 2), and a key performance indicator (KPI) counter 334. The RTPG 322 may include a VVM module 330 (e.g., the VVM module 230 of FIG. 2). The logic flow 300 may include one or more aspects described with respect to FIG. 2. In aspects, the logic flow 300 is performed by the VVM module 330 to determine whether to a particular UE is eligible for VVM provisioning. Each of the preceding NFs may take different forms, including consolidated or distributed forms that perform the same general operations. In other architectures or protocols, the NFs may be given other names, however, the NFs herein refer to functions, not specifically identified components.

The logic flow 300 includes the KPI counter 334, which is generally responsible for collecting, storing, organizing, and/or allocating KPIs associated with the logic flow 300. For example, if a UE is found to be excluded from VVM provisioning and/or is ineligible for VVM provisioning, the occurrence of each of these determinations may be communicated to the KPI counter 334 by the VVM module 330. Further, for example, if the UE is found to be eligible to use VVM, the occurrence of this determination may similarly be communicated to the KPI counter 334. In aspects, the KPI counter 334 is a subcomponent and/or a module of one of the EIR 320, the RTPG 322, or the NDS 326. In some aspects, the KPI counter 334 collects, stores, and organizes the determinations in the KPI counter 334, and in other aspects, the KPI counter 334 collects, organizes, and allocates the determinations to other network components or other NFs (e.g., the NDS 326, a performance management system (PMS), a network management system (NMS)). The KPI counter 334 may additionally collect, store, organize, and/or allocate data associated with the determination, such as the information relevant to the determination (e.g., the device identifier information, the VMR information, the MNO information, the device software information) and which information was dispositive in making the determination. The KPI counter 334 may collect metadata such as time of determination, network access type of the UE, and the like.

In aspects, the logic flow 300 may be initiated by the RTPG 322 and/or the VVM module 330 receiving an indication to initiate the logic flow 300. The VVM module 330 may be configured to initiate the logic flow 300 upon receipt of the indication. In some aspects, the indication is received by the RTPG 322 and/or the VVM module 330 from one of the NDS 326 or the EIR 320. The EIR 320 may be configured to identify particular device changes associated with the UE, and in response, notify the RTPG 322 and/or the VVM module 330 of the UE changes (e.g., in the indication to initiate the logic flow 300). The NDS 326 may be configured to identify particular provisioning changes associated with the UE (e.g., changes received from the PGW 328 and/or the HSS 324), and in response, notify the RTPG 322 and/or the VVM module 330 of the provisioning changes (e.g., in the indication to initiate the logic flow 300). In other aspects, the indication to initiate the logic flow 300 may be communicated by only the NDS 326. In such aspects, the EIR 320 may communicate with the NDS 326 and update one or more profiles of the NDS 326 (e.g., user, subscriber, and/or UE profiles) to include one or more device changes associated with the UE. In such aspects, the NDS 326 may be configured to identify specified provisioning and device changes (e.g., which may be received from the EIR 320, the HSS 324 and/or the PGW 328) associated with the UE, and in response, notify the RTPG 322 and/or the VVM module 330 of the provisioning changes and/or device changes (e.g., in real-time), causing the logic flow 300 to initiate. In other aspects, the logic flow 300 is manually initiated, such as by an MNO.

Provisioning changes associated with the UE may take a number of possible forms. Provisioning changes generally include changes to service and/or subscription plans the UE is associated with, changes to the subscriber identity module (SIM) card, mobile station international subscriber directory number (MSISDN) changes, service activation, service deactivation, service reactivation, and the like. A user associated with the UE may elect to increase their QoS of the subscription plan associated with the UE, add additional services (e.g., purchase a visual voicemail (VVM) plan), bundle various services and/or UEs together, extend the duration of the subscription plan, for example. The provisioning changes may include any one or more modifications to profiles associated with the UE (e.g., a voicemail profile associated with the UE undergoes a change). The UE may change its MSISDN, be associated with a new or altered subscription plan, be associated with a new subscriber identity module (SIM) card, and the like, each of which may be considered provisioning changes.

Device changes associated with the UE may take a number of possible forms. Device changes may include a UE's initial registration with the network (e.g., the EIR 320 receives an attach request from the UE), receiving a new or unrecognized device identifier (e.g., an international mobile equipment identity (IMEI)) (e.g., at the NDS 226, at the EIR 320), identifying a roaming UE, and the like. For example, the UE may be associated with a network in Country 1 (e.g., a home network), and the UE roams into Country 2 (e.g., a visiting network). In this example, the HSS 224 communicates with the visiting network of Country 2 to provide updated information about the UE. The occurrence of this updated information (e.g., logging the updated location information in one or more profiles associated with the UE) (e.g., at the HSS 324) may cause the indication to be communicated to the VVM module 230.

Once the logic flow 300 is initiated, the VVM module 330 may retrieve device information associated with a UE (e.g., the first UE 202 and/or the second UE 204 of FIG. 2). Device information may include any one or more of device identifier information, VMR information, MNO information, and device software information. In some aspects, the VVM module 330 retrieves the device information before making any determinations based on the device information. In other aspects, the VVM module 330 retrieves device information sequentially. For example, the VVM module 330 may first retrieve the device identifier information and make one or more device identifier determinations 336 prior to retrieving additional device information. Advantageously, if a UE is found to be excluded from VVM provisioning (e.g., the UE is excluded from continuing the logic flow 300) at an initial determination, it may be an inefficient use of network resources to preemptively retrieve additional device information. In aspects, one or more NFs may assist the VVM module 330 in accessing at least some of the device information, such as an NF directing the VVM module 330 to a particular database or a particular area of the NDS 326.

In aspects, the logic flow 300 includes the VVM module 330 making one or more determinations based on at least some of the device information. In aspects, during the logic flow 300, the VVM module 330 may determine to exclude the UE from VVM provisioning such that the logic flow 300 terminates. In aspects, the VVM module 330 logs the one or more determinations in the KPI counter 334.

The VVM module 330 may retrieve device identifier information associated with the UE and/or a user associated with the UE. Device identifier information may include any one or more of a MSISDN, an international mobile subscriber identity (IMSI), an IMEI, an IMEI software version (IMEISV), an IP address, globally unique permanent identifier (GUPI), subscription permanent identifier (SUPI), and the like. In some aspects, the VVM module 330 retrieves the device identifier information from the indication causing the logic flow 300 to initiate. For example, the VVM module 330 may receive a notification and/or communication (i.e., the indication) from the RTPG 322 and/or the NDS 326. In some aspects, at least some of the device identifier information is retrieved from the indication. In other aspects, the VVM module 330 retrieves the device identifier information from the EIR 220 and/or NDS 326, such as from one or more profiles stored at the NDS 326.

The VVM module 330 may make one or more device identifier determinations 336 based on the device identifier information. In aspects, the VVM module 330 may use the device identifier information to retrieve one or more activity statuses from the NDS 326. In aspects, the VVM module 330 may retrieve the one or more activity statuses from another NF, such as the HSS 324, a unified data management (UDM) function, and the like. As used herein, one or more activity statuses include one or more subscription statuses (e.g., the UE is not associated an active subscription and/or an active subscriber), billing statuses (e.g., a user associated with the UE has not paid the bill), deactivation statuses (e.g., the UE has not used the network for a specified duration), SIM card statuses (e.g., the UE's SIM card is deactivated), and the like. In such aspects, the VVM module 330 may determine, based on the device identifier information, that the UE and/or user associated with the device identifier information is inactive. For example, the VVM module 330 may retrieve the MSISDN associated with the UE and determine the MSISDN is inactive (e.g., based on the one or more activity statuses). When the UE is determined as inactive, the VVM module 330 may determine the UE is excluded from VVM provisioning (e.g., the UE is excluded from further analysis of the logic flow 300) and logs the occurrence of the one or more device identifier determinations 336 at the KPI counter 334. When the UE is determined as active, the logic flow 300 continues.

The one or more device identifier determinations 336 may include determining what original equipment manufacturer (OEM) the UE is associated with. In aspects, the logic flow 300 may be designed to target one or more particular OEMs (e.g., Apple) and/or one or more particular operating systems associated with the one or more OEMs (e.g., iOS). The one or more device identifier determinations 336 may include determining whether the OEM the UE is associated with is proper (e.g., whether the OEM is a target of the logic flow 300). When the UE is determined as being associated with an improper OEM (e.g., an OEM that is not the target of the logic flow 300), the VVM module 330 may determine the UE is excluded from VVM provisioning (e.g., the UE is excluded from further analysis of the logic flow 300) and logs the occurrence of the one or more device identifier determinations 336 at the KPI counter 334. When the UE is determined as being associated with the proper OEM, the logic flow 300 continues.

The VVM module 330 may retrieve VMR information associated with the UE. In aspects, the VVM module 330 retrieves the VMR information from the NDS 326, such as from one or more profiles associated with the UE, and/or from the VVM module's 330 own storage. In aspects, the VMR information includes a VMR profile associated with the UE. The VMR information may include a VMR platform identifier (ID) (which may be obtained from the VMR profile), which may indicate a network component or NF that stores other VMR information. For example, the VMR platform ID may be used to determine one or more gateways and/or servers associated with the UE (e.g., a web service gateway (WSG), a VMR server). In aspects, the VMR platform ID may be used to determine a fully qualified domain name (FQDN) corresponding to the one or more gateways and/or servers associated with the UE. The VMR information may include identifiers of the one or more gateways and/or servers associated with the VMR platform ID associated with the UE.

The VVM module 330 may make one or more VMR determinations 338 based on the VMR information. In aspects, the one or more VMR determinations 338 include one or more determinations regarding the VMR profile associated with a UE, such as whether the VMR platform is available (e.g., present, accessible, not corrupted). In aspects, the VVM module 330 determines the VMR profile associated with UE is not available, and determines the UE is excluded from VVM provisioning (e.g., the UE is excluded from further analysis of the logic flow 300) and the determination is logged in the KPI counter 334. The one or more VMR determinations 338 may include determining whether a VMR platform ID (e.g., obtained from the VMR profile) is available (e.g., present, accessible, not corrupted). In aspects, the VVM module 330 determines the VMR platform ID associated with the UE is or is not available, and determines the UE is excluded from VVM provisioning (e.g., the UE is excluded from further analysis of the logic flow 300), and the determination is logged in the KPI counter 334. The one or more VMR determinations 338 may include determining which gateway and/or server (e.g., web service gateway (WSG)) is associated with the VMR platform ID associated with the UE. In aspects, the VVM module 330 determines the VMR platform ID is not mapped to a particular gateway and/or server such that the identity of the gateway and/or server is unavailable. In such aspects, the VVM module 330 may determine the UE is excluded from VVM provisioning (e.g., the UE is excluded from further analysis of the logic flow 300), and the determination is logged in the KPI counter 334. In other aspects, the VVM module 330 determines an identity (e.g., FQDN) of which particular gateway and/or server is associated with the VMR platform ID. In such aspects, the logic flow 300 continues, and the identity of the particular gateway and/or server associated with the VMR platform ID may be used to make further determinations in the logic flow 300.

The VVM module 330 may retrieve mobile network operator (MNO) information associated with the UE. In aspects, the VVM module 330 may retrieve the MNO information from one or more of its own stored information, from the particular gateway and/or server associated with the VMR platform ID, and/or from the NDS 326. MNOs may engage in network sharing agreements and provide access to their infrastructure enabling MNOs without their own network infrastructure to utilize their resources. For example, MNO 1 may to allow MNO 2's subscribers to access MNO 1's network. In this example, MNO 2 may not have negotiated for VVM provisioning for its subscribers, and thus MNO 2's subscribers may be excluded from VVM provisioning.

The MNO information may include a particular MNO the UE is associated with (e.g., MNO 1, MNO 2). In aspects, the VVM module 330 retrieves a public land mobile network (PLMN) identifier and/or an IMEI (which may have been retrieved with the device identifier information) associated with the UE. Each of the PLMN and the IMEI include a mobile country code (MCC) and a mobile network code (MNC), allowing the network to determine the particular MNO the user is associated with. In aspects, the MNO the UE is associated with may be a host MNO (e.g., the MNO that owns, operates, and/or manages the network). The MNO information may include whether the MNO the UE is associated with is eligible for VVM provisioning or whether the MNO the UE is associated with is excluded from VVM provisioning, which may be reflected in an exclusion status. For example, the network sharing agreement between MNO 1 and MNO 2 may not entitle MNO 2 to VVM provisioning.

The MNO information may include one or more exclusion statuses for each MNO associated with UEs who access the network. In aspects, the VVM module 330 may query the gateway and/or server associated with the VMR platform ID associated with the UE to retrieve the one or more exclusion statuses, and/or the VVM module 330 may store exclusion statuses for each MNO associated with UEs who access the network. The exclusion statuses may take one or more forms. In aspects, the exclusion status may be a presence indicator such that the presence of the status indicates whether the MNO is excluded from VVM provisioning or whether the MNO is not excluded from VVM provisioning. In other aspects, the exclusion status may be a value indicator such that the value of the status indicates whether the MNO is excluded or not excluded from VVM provisioning. In some aspects, the exclusion status is a class of service identifier (COS-ID) representing the MNO's entitlement to VVM provisioning for its subscribers.

The VVM module 330 may make one or more MNO determinations 340 based on the MNO information. The one or more MNO determinations 340 may include the VVM module 330 determining which MNO the UE is associated with based on the PLMN and/or the IMEI associated with the UE. In aspects, the one or more MNO determinations 340 may include the VVM module 330 determining the UE is associated with the host MNO (e.g., the MNO that owns, operates, and/or manages the network) (e.g., MNO 1 in the above example) or a direct partner of the host network (e.g., an MNO branded differently than the host MNO but owned, operated, and/or managed by the host MNO). In such aspects, based on this determination, the VVM module 330 determines the UE is eligible for VVM provisioning and the logic flow 300 continues. In aspects, the one or more MNO determinations 340 includes the VVM module 330 determining the MNO the UE is associated with has an exclusion status indicating the MNO, and thus the UE, are eligible for VVM provisioning (e.g., the MNO has negotiated for such a benefit with the host MNO). In such aspects, the logic flow 300 continues. In aspects, the one or more MNO determinations 340 includes the VVM module 330 determining the MNO the UE is associated with has an exclusion status indicating the MNO, and thus the UE, are excluded from VVM provisioning. In such aspects, the VVM module 330 may log the determination in the KPI counter 334.

The VVM module 330 may retrieve device software information associated with the UE. The device software information may include what software version is associated with the UE. Device software information may include an international mobile equipment identity software version (IMEISV) (which may have already been obtained with the device identifier information). For example, the IMEI may indicate the particular UE type, OEM, model, production date, and the like, and the IMEISV additionally provides a software version (e.g., the most recent software version incorporated into the UE's operating system) associated with the UE. In some aspects, the software version may be unavailable (e.g., not present, inaccessible, corrupted). In aspects, the IMEISV is obtained from the NDS 326 and/or the EIR 320.

The VVM module 330 may make one or more device software determinations 342 based on the device identifier information and/or the device software information. The one or more device software determinations 342 may include whether the device software information is available. In aspects where the device software information is unavailable, the VVM module 330 determines the UE is excluded from VVM provisioning and logs the determination in the KPI counter 334. In aspects where the device software information is available, the VVM module 330 may make additional device software determinations 342. The one or more device software determinations 342 may include the VVM module 330 determining the device software information associated with the UE is a software version compatible with VVM provisioning. For example, a UE may be an older model smartphone such that when the UE was manufactured, the UE was not compatible with VVM provisioning, but has since updated its software such that the software version of the UE is compatible with VVM provisioning. In aspects where the UE is associated with a software version compatible with VVM provisioning, the VVM module 330 determines the UE is eligible for VVM provisioning and the logic flow 300 continues. In aspects where the UE is not associated with a software version compatible with VVM provisioning, the VVM module 330 may determine the UE is ineligible for VVM provisioning and the logic flow 300 continues.

The VVM module 330 may make one or more provisioning indicator modifications 344 based on the one or more determinations made during the logic flow 300. In aspects, modification includes both creating a provisioning indicator, removing a provisioning indicator, and/or modifying the value of a provisioning indicator. In aspects where the UE is ineligible for VVM provisioning (e.g., is associated with a software version incompatible with VVM provisioning), the VVM module 330 may determine the lack, the presence, and/or the value of the provisioning indicator is improper and/or inaccurate and create, remove, and/or modify the value of the provisioning indicator to indicate the UE is ineligible for VVM provisioning. In aspects where the UE is eligible for VVM provisioning (e.g., is associated with a software version compatible with VVM provisioning), the VVM module 330 may determine the lack, the presence, and/or the value of the provisioning indicator is improper and/or inaccurate and create, remove, and/or modify the value of the provisioning indicator to indicate the UE is eligible for VVM. The VVM module 330 may add a modified provisioning indicator to a profile associated with the UE (e.g., at the NDS 326 and/or the EIR 320). In some aspects, the modified provisioning indicator indicates whether the UE is entitled to VVM provisioning such that VVM is provisioned to the UE (e.g., upon the addition of the modified provisioning indicator to one or more profiles associated with the UE, upon a subsequent registration of the UE to the network). In some aspects, the provisioning indicator modification 344 is logged at the KPI counter 334.

While the above determinations described with respect to FIG. 3 are described in a specific sequence, the one or more determinations may be completed in a different order than described. As one illustrative example, the VVM module 330 may make the one or VMR determinations 338 prior to the one or more device identifier determinations 336. The criteria and/or considerations evaluated by the VVM module 330 to make the one or more determinations may be altered, such as by the host MNO (e.g., the MNO that owns, operates, and/or manages the network).

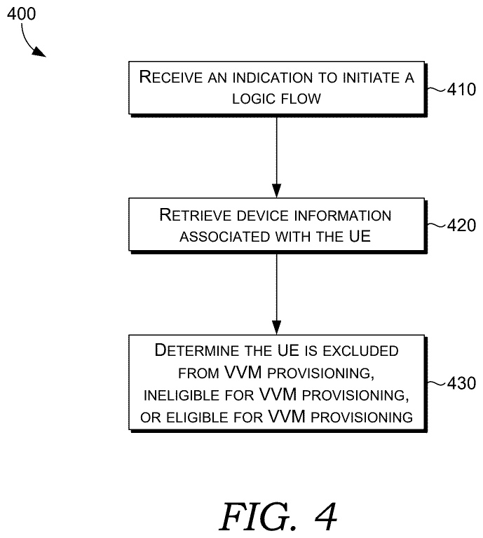

Turning now to FIG. 4, a flow chart is provided that illustrates one or more aspects of the present disclosure relating to a method 400 for determining whether to provision visual voicemail (VVM) to a UE. The method 400 may include one or more aspects described with respect to FIGS. 2-3.

At a first step 410, a VVM module (e.g., the VVM module 230 of FIG. 2, the VVM module 330 of FIG. 3) receives an indication to initiate the logic flow (e.g., the logic flow 300 of FIG. 3). In aspects, the indication is based on one or more of a device change and/or a provisioning change associated with the UE, as described with respect to FIG. 3. At a second step 420, the VVM module retrieves device information associated with the UE. In aspects, the VVM module retrieves the device information during the logic flow. The device information may include any one or more of device identifier information, VMR information, MNO information, and/or device software information associated with the UE, as described with respect to FIG. 3.

At a third step 430, the VVM module determines whether the UE is excluded from VVM provisioning, is eligible for VVM provisioning, or is ineligible for VVM provisioning. In aspects, during the logic flow, the VVM module may make one or more determinations (e.g., the one or more device identifier determinations 336, the one or more VMR determinations 338, the one or more MNO determinations 340, and/or the one or more device software determinations 342 of FIG. 3), as described with respect to FIG. 3. In aspects, the VVM module may determine the UE is excluded from VVM provisioning and log one or more determinations at a KPI counter (e.g., the KPI counter 334 of FIG. 3) without modifying a provisioning indicator associated with the UE. In aspects, the VVM module determines the UE is ineligible for VVM provisioning, may modify (e.g., create, remove, modify the value of, a combination thereof) a provisioning indicator associated with the UE, and/or log the occurrence of this modification with the KPI counter (e.g., the KPI counter 334 of FIG. 3), as described with respect to FIG. 3. For example, the VVM module may create a provisioning indicator associated with the UE to indicate the UE is not entitled to VVM provisioning. In aspects, the VVM module may determine the UE is eligible for VVM provisioning, may modify a provisioning indicator associated with the UE, and/or log the occurrence of this modification at the KPI counter. For example, the VVM module may create a provisioning indicator associated with the UE to indicate the UE is entitled to VVM provisioning.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for determining whether to provision visual voicemail (VVM) to a user equipment (UE), the method comprising:
receiving, at a VVM module, an indication to initiate a logic flow;
retrieving, by the VVM module during the logic flow, device information; and
based on the device information, determining whether to modify a provisioning indicator.

2. The method of claim 1, wherein the device information includes device identifier information, voicemail routing (VMR) platform information, mobile network operator (MNO) information, and device software information.

3. The method of claim 1, further comprising refraining from modifying the provisioning indicator based on the device information indicating the UE is associated with an MNO ineligible for VVM provisioning.

4. The method of claim 1, further comprising refraining from modifying the provisioning indicator based on the device information indicating the UE is not associated with an active subscription or an active subscriber.

5. The method of claim 1, further comprising modifying the provisioning indicator to generate a modified provisioning indicator based on determining a software version of the UE is compatible with VVM provisioning, wherein the modified provisioning indicator indicates the UE is entitled to VVM provisioning.

6. The method of claim 1, further comprising modifying the provisioning indicator to generate a modified provisioning indicator based on determining a software version of the UE is incompatible with VVM provisioning, wherein the modified provisioning indicator indicates the UE is not entitled to VVM provisioning.

7. The method of claim 1, wherein the indication indicates one of a device change or a provisioning change associated with the UE.

8. The method of claim 7, wherein the indication indicates the device change, and wherein the device change comprises the UE's registration with a network.

9. A method for determining whether to provision visual voicemail (VVM) to a user equipment (UE), the method comprising:
receiving, at a VVM module, an indication to initiate a logic flow;
retrieving, by the VVM module during the logic flow, device information;
based on the device information, determining the UE is excluded from VVM provisioning; and
logging the determination that the UE is excluded from VVM provisioning in a key performance indicator (KPI) counter.

10. The method of claim 9, wherein the device information includes device identifier information, voicemail routing (VMR) platform information, mobile network operator (MNO) information, and device software information.

11. The method of claim 10, wherein the indication indicates one of a device change or a provisioning change associated with the UE.

12. The method of claim 11, wherein determining the UE is excluded from VVM provisioning is based on the device identifier information indicating the UE is not associated with an active subscription or an active subscriber.

13. The method of claim 11, wherein determining the UE is excluded from VVM provisioning is based on the MNO information indicating the UE is not associated with an MNO eligible for VVM provisioning.

14. The method of claim 11, wherein determining the UE is excluded from VVM provisioning is based on the VMR information indicating the UE is not associated with an available voicemail routing (VMR) profile.

15. A method for determining whether to provision visual voicemail (VVM) to a user equipment (UE), the method comprising:
receiving, at a VVM module, an indication to initiate a logic flow;
retrieving, by the VVM module during the logic flow, device information; and
based on the device information, determining whether to exclude the UE from VVM provisioning or whether to modify a provisioning indicator associated with the UE to generate a modified provisioning indicator, wherein the modified provisioning indicator indicates the UE is either entitled to VVM provisioning or not entitled to VVM provisioning.

16. The method of claim 15, further comprising:
determining to exclude the UE from VVM provisioning based on determining one or more of:
the UE is not associated with an active subscription or active subscriber,
the UE is associated with a mobile network operator (MNO) ineligible for VVM provisioning,
the UE is not associated with an available VMR profile,
a software version of the UE is incompatible with VVM, and
logging the determination to exclude the UE from VVM provisioning in a key performance indicator (KPI) counter.

17. The method of claim 15, further comprising modifying the provisioning indicator, wherein the modified provisioning indicator indicates the UE is either entitled to VVM provisioning or is not entitled to VVM provisioning, and wherein the modified provisioning indicator is added to a profile associated with the UE.

18. The method of claim 17, wherein the modified provisioning indicator indicates the UE is entitled to VVM provisioning based on a software version of the UE being compatible with VVM provisioning.

19. The method of claim 17, wherein the modified provisioning indicator indicates the UE is not entitled to VVM provisioning based on a software version of the UE being incompatible with VVM provisioning.

20. The method of claim 15, wherein the device information includes device identifier information, voicemail routing (VMR) platform information, mobile network operator (MNO) information, and device software information.
